(19) United States
(12) Patent Application Publication
(10) Pub. No.: US 2010/0029420 A1
(43) Pub. Date: Feb. 4, 2010

(54) Football and Method for Manufacturing Same

(75) Inventors: Chunwei Jerry HU, Canton, MA (US); Christopher Michael Waldeck, Canton, MA (US)

Correspondence Address: STERNE, KESSLER, GOLDSTEIN & FOX, P.L.L.C., 1100 NEW YORK AVENUE, N.W., WASHINGTON, DC, 20005, US

(73) Assignee: Reebok International Ltd., Canton, MA (US)

(21) Appl. No.: 12/576,767

(22) Filed: Oct. 9, 2009

Related U.S. Application Data
(62) Division of application No. 11/035,421, filed on Jan. 14, 2005, now abandoned.

(51) Int. Cl. A63B 41/08; B65H 81/06; B32B 7/08

(52) U.S. Cl. 473/599; 156/185; 156/91

(57) ABSTRACT

A football includes an inflatable bladder; a layer of wound filament fibers surrounding the inflatable bladder; a carcass surrounding the layer of wound filament fibers, including raised areas and recessed areas and a plurality of panels positioned within the recessed areas of the carcass. An outer surface of the plurality of panels is flush with an outer surface of the raised areas of the carcass, which includes the appearance of at least one of stitching, seams and a pebbled outer surface. A method of manufacturing a football includes providing an inflatable bladder, winding filament fibers around the bladder and molding a carcass around the fibers. The carcass is molded to include recessed areas, raised areas and the appearance of at least one of seams, stitching and a pebbled surface on the raised areas. Panels are then laminated to the recessed areas of the carcass.

### CROSS REFERENCE TO RELATED APPLICATIONS

This application is a divisional of U.S. application Ser. No. 11/035,421, filed on Jan. 14, 2005, which is hereby incorporated by reference in its entirety.

### FIELD OF THE INVENTION

The present invention relates generally to a football and a method for manufacturing a football.

### BACKGROUND OF THE INVENTION

Footballs are generally made by sewing together panels of synthetic or natural leather together leaving an unstitched portion to insert an inflatable bladder. Once the bladder has been inserted, the unstitched portion is pulled together and closed using lacing, which also helps the user to throw the football. Synthetic and natural leather gives footballs a desirable look and feel. However, the material is particularly expensive and the process is labor-intensive in that each panel must be sewn together. In other words, footballs made with natural or synthetic leather materials by this method are particularly expensive. Also, due to the variances in sewing and in the synthetic of natural leather, often footballs do not have a consistent appearance, shape or feel from one to another. Additionally, stitched footballs are not sufficiently waterproof, since water may seep through the stitched areas of the football and/or penetrate the leather surface, even when water proof treatments are applied thereto.

In order to correct the problem of consistency, a football has been made which includes techniques generally used for making basketballs. In this type of football 100, a cross section of which, for example, is shown in FIG. 1, an inflatable bladder 102 is covered first with a wound filament layer 104 and then with a thermoplastic rubber carcass 106. Synthetic or natural leather panels 108 are then laminated to and over the thermoplastic rubber carcass, leaving a rim 107 of carcass exposed and slightly recessed between each panel 108. In basketballs, the exposed rim forms the traditional channels on a basketball, which are about 0.25 inch wide. In a football, however, the exposed rims form the same about 0.25 inch wide channels between panels 108, which are uncharacteristic of a conventional sewn football. As such, football 100 does not have the appearance of a conventional football, complete with the appropriate stitching. Football 100 also uses synthetic or natural leather over all but the very small rim 107 around the football, maintaining the undesirable costs of the conventional football.

In another method for making game balls, exterior synthetic or natural leather panels are not used. Instead, an exterior thermoplastic rubber carcass is molded to form pebbles all over the ball in order that the ball have a texture that is similar to that of synthetic or natural rubber. However, a football made from this practice does not provide a particular area in order to sew laces thereto, similar to the laces of a conventional football, since there is no fabric component. Any ornamental lacing must be attached to the exterior of the football, which provides an unsatisfactory look and feel to the laces. Further, a football made from this process does not have the superior look and feel provided by a natural or synthetic leather covering.

### BRIEF SUMMARY OF THE INVENTION

Further embodiments, features, and advantages of the present invention, as well as the structure and operation of the various embodiments of the present invention, are described in detail below with reference to the accompanying drawings.

In one embodiment, a football includes an inflatable bladder; a layer of wound filament fibers surrounding the inflatable bladder; a carcass surrounding the layer of wound filament fibers, including raised areas and recessed areas and a plurality of panels positioned within the recessed areas of the carcass. An outer surface of the plurality of panels is flush with an outer surface of the raised areas of the carcass. The outer surface of the raised areas of the carcass includes the appearance of at least one of stitching, seams and a pebbled outer surface.

In another embodiment of the present invention, a method of manufacturing a football includes a first step of providing an inflatable bladder. Filament fibers are wound around the bladder. A carcass is molded around the filament fibers. The molding of the carcass includes forming recessed areas, raised areas and the appearance of at least one of seams, stitching and a pebbled surface on the raised areas. Panels are then laminated to the recessed areas of the carcass.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a sectional view of a game ball.

FIG. 2 is a sectional view of a football of the present invention.

FIG. 3 is a side plan view of a football of the present invention.

FIG. 4 is an end view of the football of FIG. 3.

FIG. 5 is a side plan view of another embodiment of a football of the present invention.

FIG. 6 is a perspective view of the football of FIG. 5.

FIG. 7 is an end view of the football of FIG. 5.

FIG. 8 is a top plan view of another embodiment of a football of the present invention.

FIG. 9 is a bottom plan view of the football of FIG. 8.

FIG. 10 is a side plan view of the football of FIG. 8.

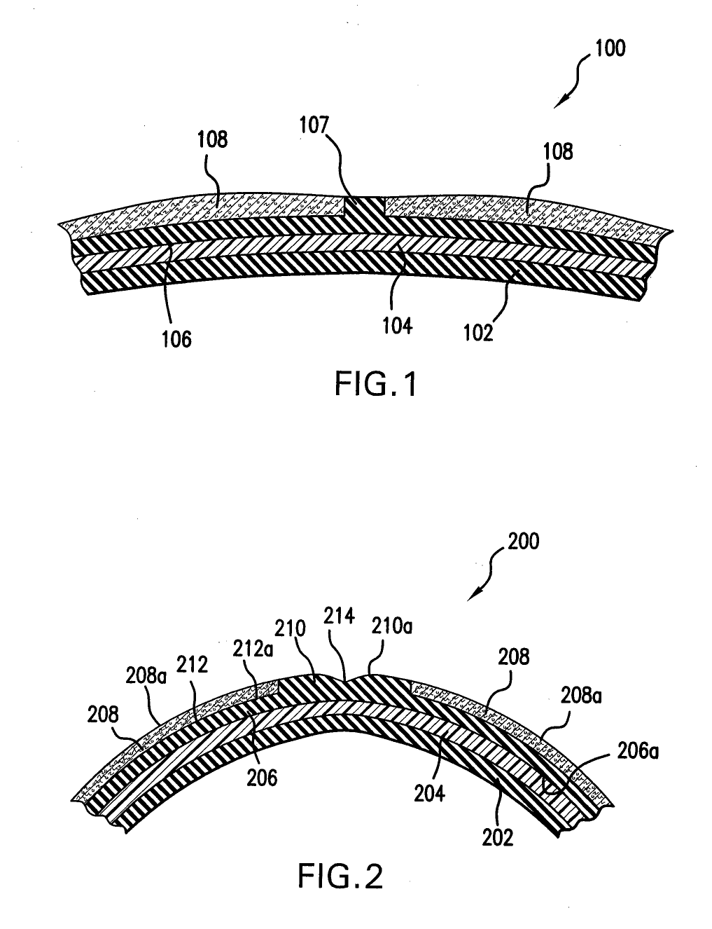

### DETAILED DESCRIPTION OF THE INVENTION

The present invention will be described with reference to the accompanying drawings. The drawing in which an element first appears is typically indicated by the leftmost digit(s) in the corresponding reference number.

A football 200 of the present invention is shown in FIG. 2. The football includes a bladder 202. Bladder 202 is surrounded by a wound filament layer 204, which is surrounded by an impregnated with a carcass 206. Carcass 206 consists of substantial raised areas 210 and recessed areas 212. Football 200 also includes panels 208, which are disposed within the recessed areas 212 of carcass 206.

Bladder 202, when inflated provides support to the football and provides the bounce when the football contacts the ground. Bladder 202 may be made from any material suitable for a bladder of a game ball. For example, bladder 202 may be made from butyl rubber, polyurethane, latex or a butyl and natural rubber compound, with better air retention as the percentage of butyl rubber over natural rubber increases. Preferably bladder 202 is oval- or egg-shaped to generally correspond to the shape of the finished football.

Filament layer 204 helps bladder 202 retain the correct shape when inflated. Filament layer 204 may be any filament suitable for a winding around a bladder of a game ball. For example, the filament layer may be made from nylon, or a nylon/polyester blend threads or fibers which are wound repeatedly around bladder 202.

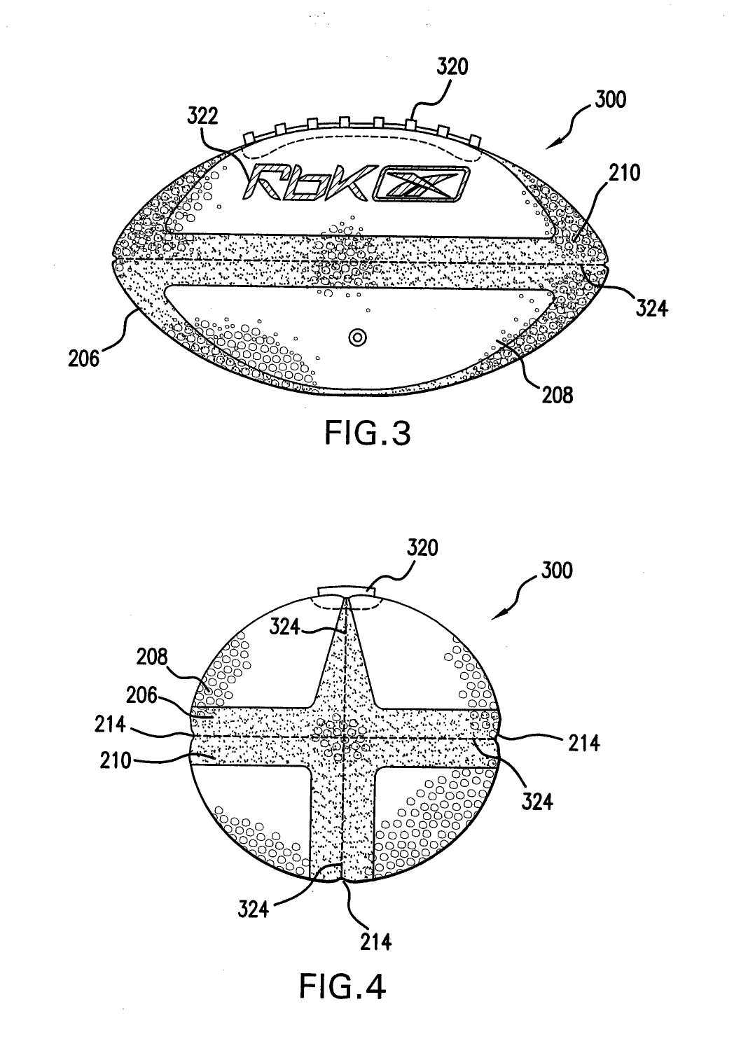

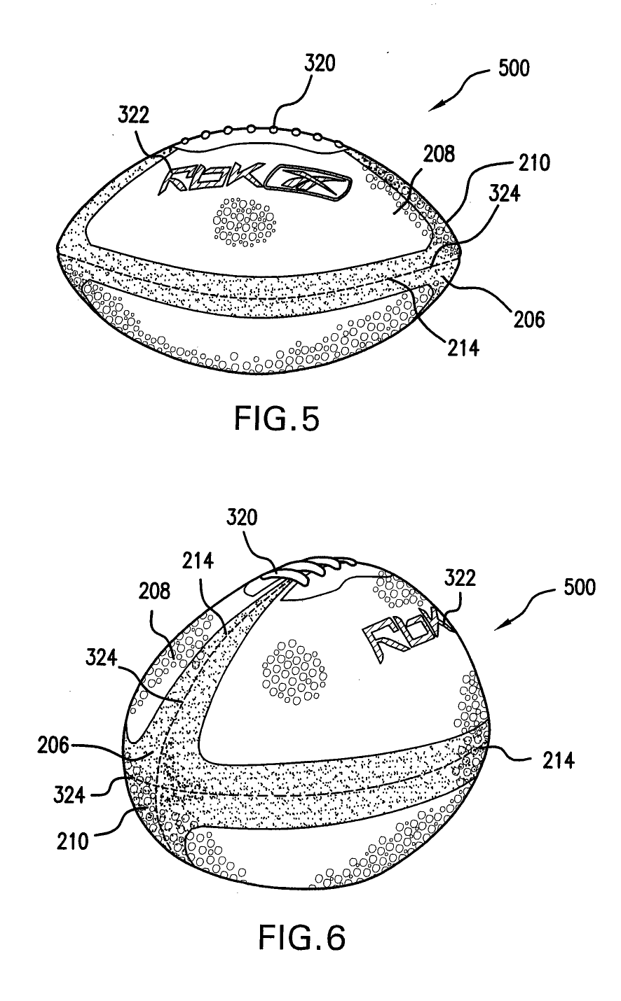

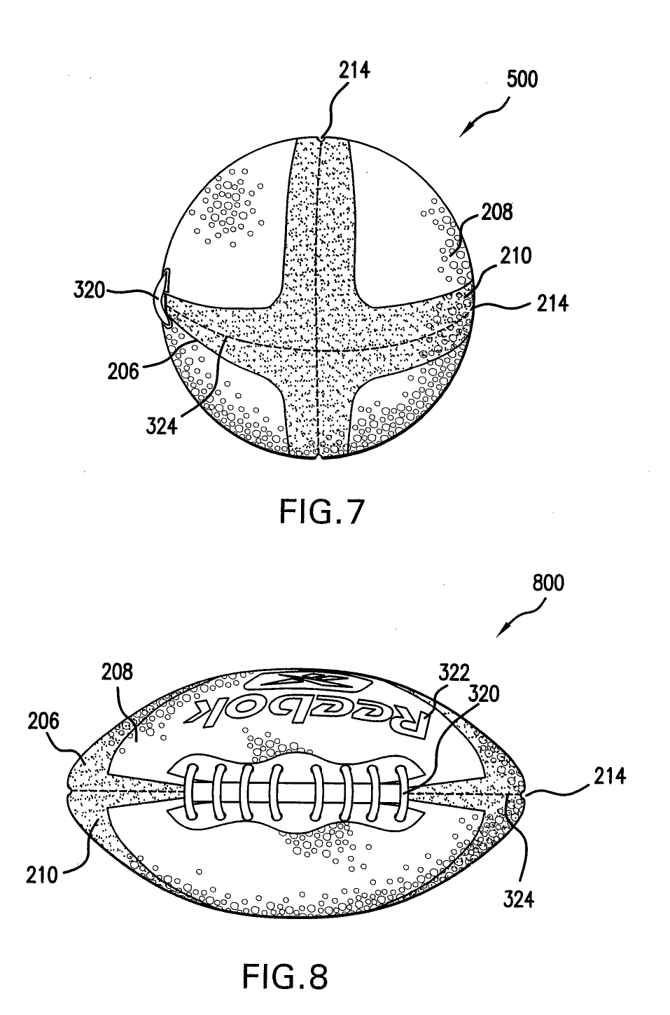

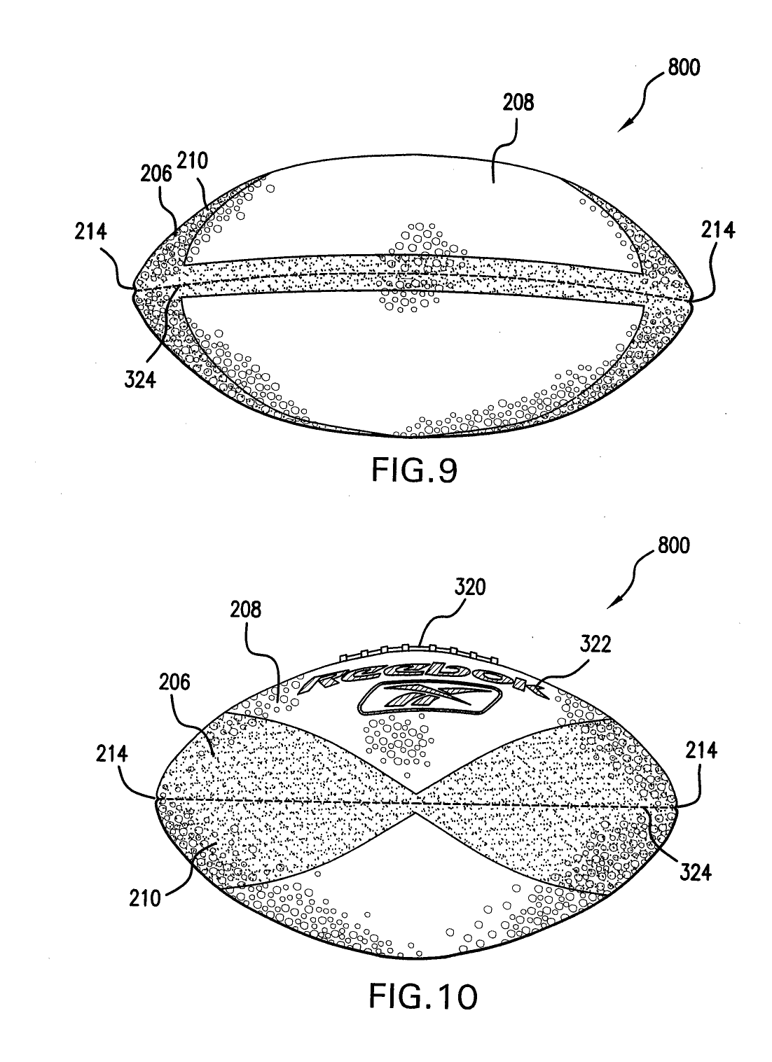

Carcass 206 is made from a moldable rubber sheet, which is placed around filament layer 204. For example, the rubber sheet may be synthetic rubber, natural rubber, sponge rubber, a combination thereof or any other moldable rubber suitable for use as a carcass in game balls. The carcass is then molded into the desired football shape with raised areas 210 and recesses 212. Recesses 212 have a generally smooth outer surface 212a. Meanwhile, raised areas 210 are also molded such that an outer surface 210a of raised areas 210 forms a pebbled surface, which matches the pebbled outer surface 208a of the natural or synthetic leather panels 208. Also, raised areas 210 are molded to include seams 214 and the appearance of stitching 324 along seams 214, which is shown more clearly in examples provided herein: football 300 shown in FIGS. 3-4, football 500 shown in FIGS. 5-7 and football 800 shown in FIGS. 8-10.

Carcass 206 is molded by placing the football into a mold and applying heat to the thermoplastic rubber material. Outer surfaces 210a and 212a of carcass 206 conform to the mold as discussed above, while the inner surface 206b of the carcass 206 is pressed into and becomes embedded within the filament layer 204 to bind carcass 206 in place.

Panels 208 are die cut into the preferred shape, and include holes for laces 320. Once the carcass 206 has been molded, panels 208 made from natural or synthetic leather are laminated to recessed areas 212 of carcass 206, everywhere except directly under laces 320. In this area, a tongue (not shown) is positioned between panel 208 and recessed area 212 of carcass 206. The tongue is includes so that when the panel material is laced, the needle used to lace the football does not puncture the carcass 206. The tongue may be any material sufficient to create a barrier to avoid piercing carcass 206 during lacing, for example, a small piece of a hard thermoformed plastic or cotton/polyester blend padding. Once panels 208 are laminated to carcass 206, laces 320 are laced through panel 208 as shown in the examples of FIGS. 3-8 and 10. Laces 320 may be a thin strap of a synthetic or natural leather material, such as a strap of rawhide.

In one embodiment, panels 208 are laminated to recessed areas 212 of carcass 206 by adhesive bonding. However, other laminating techniques used to manufacture game balls may be used to attach panels 208 to recessed areas 212 of carcass 206. Preferably, recessed areas 212 are recessed only the thickness of panel 208, such that the outer surface 208a of panel 208 is flush with outer surface 210a of raised area 210.

Panels 208 provide a natural feel to the surface of football 200. Synthetic leathers may be any conventional synthetic leathers, such as those composite materials made from polyurethane (PU) or polyvinylchloride (PVC). Panels 208 may be embossed, for example with a logo 322 or other information such as that shown in FIGS. 3, 5-6 and 8-10, prior to being laminated to carcass 206.

FIGS. 3-4 illustrate a finished football 300 according to the present invention. FIGS. 5-10 are photographs showing examples of footballs 500 and 800, respectively, formed from the method discussed above. Since raised areas 210 of carcass 206 cover a substantial area of the football, less of the expensive synthetic or natural leather material is necessary and decreasing the costs of the ball. Further, carcass 206 provides that each football 300 has a consistent shape and is waterproof. The molded outer surface 210a of raised area 210 of carcass 206 give the football 300 the appearance of a conventional stitched football, including the appearance of seams, stitching and the pebbled surface similar to that of the surface of the natural or synthetic leather panels 208.

Another advantage of having a substantial portion of the exterior of a football be a raised area 210 of carcass 206 is that the moldable rubber material of carcass 206 may easily be changed at the exact point of manufacturing football 300. The materials used to make panels 208 may also be dyed or changed, as shown in football 800 of FIGS. 8-10, but the colors must be selected and ordered from the supplier of the panel material prior to the point of manufacturing football 800. Thus, fast color changes and a variety of color options for carcass 206 are available when raised areas 210 of carcass 206 constitute substantial portions of the exterior of football 800.

In other embodiments, for example as seen football 800 of FIG. 10, raised areas 210 of carcass 206 may be any shape or size and may constitute any portion of the exterior of a football 500 provided that at least some recessed areas 212 are provide such that panels 208 may be laminated thereto, particularly in the area where laces 320 would be appropriate on a football of the present invention. For example, in one embodiment, the raised areas 210 are larger than the about 0.25 inch wide channels in conventional game balls.

In further embodiments, the raised area 210 of carcass 206 may have at least a width of about 0.5 inch, 1.0 inch, 1.5 inch or even larger between panels. Thus, another advantage of the present invention is that the dimensions of the raised area 210 of the carcass 206 are variable merely by changing the design of the mold. Although in a preferred embodiment, the raised areas 210 of carcass 206 are formed with pebbles, raised areas 210, for example greater than 0.25 inch wide or wider areas, may also be unpebbled to provide for a unique football appearance.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1-13. (canceled)

14. A method of manufacturing a football, comprising the steps of:
providing an inflatable bladder;
winding filament fibers around said bladder;
molding a carcass around said filament fibers, wherein said molding includes forming recessed areas and a plurality of raised areas, wherein at least one of said plurality of raised areas has a width of at least 0.5 inches; and
laminating panels to said recessed areas of said carcass.

15. The method of claim 14, further including the step of die cutting said panels, wherein at least one of said panels includes holes.

16. The method of claim 15, further including the step of positioning a tongue between said at least one of said panels and said carcass adjacent said holes.

17. The method of claim 16, wherein said tongue is selected from the group comprising a hard thermoplastic material or a cotton and polyester blend padding.

18. The method of claim 15, further including the step of lacing laces between said holes.

19. The method of claim 14, wherein an outer surface of said raised areas of said carcass constitutes a substantial portion of an exterior of said football.

20. The method of claim 14, wherein said step of laminating said panels to said recessed areas of said carcass includes bonding using adhesives.

21. The method of claim 14, wherein an outer surface of said panels is flush with an outer surface of said raised areas of said carcass.

22-27. (canceled)

28. The method of claim 14, wherein at least one of said plurality of raised areas has a non-uniform width.

29. The method of claim 14, wherein at least one of said plurality of raised areas has a tapered width.

30. The method of claim 14, wherein at least one of said plurality of raised areas extends from a first end of said football to a second end of said football and has a tapered width such that said at least one raised area has a greater width in an area between said first and second ends of said football than at said first and second ends of said football.

31. The method of claim 14, wherein said plurality of raised areas has a pebbled outer surface and an appearance of seams and stitches.

32. The method of claim 14, wherein each of said plurality of raised areas has a width of at least 0.5 inches.

33. The method of claim 14, wherein at least one of said plurality of raised areas has a width of at least 1.0 inch.

34. The method of claim 14, wherein at least one of said plurality of raised areas has a width of at least 1.5 inches.

35. A method of manufacturing a football, comprising the steps of:
providing an inflatable bladder;
winding filament fibers around said bladder;
molding a carcass around said filament fibers, wherein said molding includes forming recessed areas and a plurality of raised areas, wherein at least one of said plurality of raised areas has a non-uniform width that changes across substantially an entire length of said at least one raised area; and
laminating panels to said recessed areas of said carcass.

36. The method of claim 35, wherein an outer surface of said laminating panels are flush with an outer surface of said plurality of raised areas of said carcass.

37. The method of claim 35, wherein at least one of said plurality of raised areas extends from a first end of said football to a second end of said football and has a tapered width such that said at least one raised area has a greater width in an area between said first and second ends of said football than at said first and second ends of said football.

38. The method of claim 35, wherein said at least one raised area has a tapered, non-uniform width.

39. The method of claim 35, wherein at least one of said plurality of raised areas has a width of at least 0.5 inches.

40. The method of claim 35, wherein at least one of said plurality of raised areas has a width of at least 1.0 inch.

41. The method of claim 35, wherein at least one of said plurality of raised areas has a width of at least 1.5 inches.
